(19) United States
(12) Patent Application Publication
(10) Pub. No.: US 2012/0278209 A1
(43) Pub. Date: Nov. 1, 2012

(54) MICRO-APP DYNAMIC REVENUE SHARING

(75) Inventors: Dang Van TRAN, Laguna Niguel, CA (US); Xing ZHENG, Irvine, CA (US); Jaffar KHOSHGOZARAN, Pasadena, CA (US); Yingnan ZHU, Irvine, CA (US)

(73) Assignee: SAMSUNG ELECTRONICS CO., LTD., Suwon City (KR)

(21) Appl. No.: 13/244,050

(22) Filed: Sep. 23, 2011

Related U.S. Application Data
(60) Provisional application No. 61/481,153, filed on Apr. 30, 2011.

(51) Int. Cl. G06Q 30/04; G06Q 10/10

(52) U.S. Cl. 705/30

(57) ABSTRACT

In a first embodiment of the present invention, a method is provided comprising: displaying full-app content using a full-app on a first device, wherein the full-app is associated with a full-app partner and was downloaded from an app store; running a micro-app simultaneously with the full-app content playing on the first device, wherein the micro-app is associated with a micro-app partner; performing a revenue generating event on the first device; retrieving current context information; dynamically assigning a percentage of shared revenue associated with the revenue generating event to each of the app store, the full-app partner, and the micro-app partner, based upon the current context information; and causing revenue associated with the revenue generating event to be shared among the app store, the full-app partner, and the micro-app partner based on the dynamically assigned percentages.

### CROSS REFERENCE TO RELATED APPLICATIONS

This application claims the benefit of priority under 35 U.S.C. 119(e) to U.S. Provisional Patent Application No. 61/481,153, filed Apr. 30, 2011, which is incorporated herein by reference for all purposes.

### BACKGROUND OF THE INVENTION

1. Field of the Invention

The present invention relates to consumer electronics. More specifically the present invention relates to dynamic revenue sharing in systems containing micro-apps.

2. Description of the Related Art

The current media playing experience is, for the most part, a non-interactive and passive experience. For example, when viewing a television program on a television, the user simply watches the television. When a user listens to a music file on a portable media player, he or she simply listens to the music. While there are mechanisms available that allow users to use the same devices to interact with other data sources, such as a mechanism provided in newer televisions allowing users to surf the Internet while watching a program, the interaction is not geared specifically for the media being played. To the extent that a user wishes to “interact” with elements related to the media being played (such as, for example, purchasing a DVD copy of a television program being viewed), the user must do so manually.

Technologies exist that allow devices that have both media player and Internet-searching abilities to automatically switch between the two based upon the function currently being performed. For example, an options panel having a set of buttons can be used both in a television-playing mode and an Internet-surfing mode, providing a unified viewing experience. However, such technologies are limited to the system simply being aware of the current function being performed by the device, and the system does not take into account other factors, such as the media being played itself.

Furthermore, media playing is currently a single-device experience. While there may be any number of users watching or hearing media from a single device (such as a family sitting down and watching television together), the experience is limited to that single-device. It is becoming more and more prevalent, however, for there to be multiple accessible (and potentially Internet-enabled) devices usable within the same general area. For example, many individuals now carry cellular phones or other mobile communications devices with them at all times, many of which are Internet-enabled. Indeed, some mobile phones are “smart” enough to be considered mini-computers rather than what traditionally would be considered a phone. Additionally, tablet computers are becoming more prevalent, as are digital picture frames, which are also becoming Internet (or at least home network) enabled.

Furthermore, so-called “app stores” have created tremendous new revenue possibilities for both app store owners and developers. These app stores, in which users can electronically purchase and download software applications directly to devices such as mobile phones and tablet computers, typically have a shared revenue business model. For example, the app store owner may take 30% of all software sales, with the developers taking 70%. This business model, however, is rather one dimensional.

What is needed is a solution that improves upon these mechanisms.

### SUMMARY OF THE INVENTION

In a first embodiment of the present invention, a method is provided comprising: displaying full-app content using a full-app on a first device, wherein the full-app is associated with a full-app partner and was downloaded from an app store; running a micro-app simultaneously with the full-app content playing on the first device, wherein the micro-app is associated with a micro-app partner; performing a revenue generating event on the first device; retrieving current context information; dynamically assigning a percentage of shared revenue associated with the revenue generating event to each of the app store, the full-app partner, and the micro-app partner, based upon the current context information; and causing revenue associated with the revenue generating event to be shared among the app store, the full-app partner, and the micro-app partner based on the dynamically assigned percentages.

In a second embodiment of the present invention, a first device is provided comprising: a processor; a display; a full-app downloaded from an app store, wherein the full-app is configured to display full-app content on the display; a micro-app downloaded from the app store, wherein the micro-app is configured to run simultaneously with the full-app content being displayed on the display; a current context retriever configured to retrieve current context information; a revenue generating event detector configured to detect a revenue generating event by the micro-app; and a revenue sharing interface designed to send the current context information to a revenue distributing entity upon the revenue generating event detector detecting a revenue generating event by the micro-app so that the revenue distributing entity can dynamically assign a percentage of shared revenue to each of the app store, a full-app partner associated with the full-app, and a micro-app partner associated with the micro-app, based on the current context information, and cause revenue associated with the revenue generating event to be shared based on the dynamically assigned percentages.

In a third embodiment of the present invention, an apparatus is provided comprising: means for displaying full-app content using a full-app on a first device, wherein the full-app is associated with a full-app partner and was downloaded from an app store; means for running a micro-app simultaneously with the full-app content playing on the first device, wherein the micro-app is associated with a micro-app partner; means for performing a revenue generating event on the first device; means for retrieving current context information; means for dynamically assigning a percentage of shared revenue associated with the revenue generating event to each of the app store, the full-app partner, and the micro-app partner, based upon the current context information; and means for causing revenue associated with the revenue generating event to be shared among the app store, the full-app partner, and the micro-app partner based on the dynamically assigned percentages.

In a fourth embodiment of the present invention, a non-transitory program storage device readable by a machine is provided tangibly embodying a program of instructions executable by the machine to perform a method comprising: displaying full-app content using a full-app on a first device, wherein the full-app is associated with a full-app partner and was downloaded from an app store; running a micro-app simultaneously with the full-app content playing on the first device, wherein the micro-app is associated with a micro-app partner; performing a revenue generating event on the first device; retrieving current context information; dynamically assigning a percentage of shared revenue associated with the revenue generating event to each of the app store, the full-app partner, and the micro-app partner, based upon the current context information; and causing revenue associated with the revenue generating event to be shared among the app store, the full-app partner, and the micro-app partner based on the dynamically assigned percentages.

### BRIEF DESCRIPTION OF THE DRAWINGS

FIG. 1 is a diagram illustrating a micro-app system in accordance with an embodiment of the present invention.

FIG. 2 is a flow diagram illustrating a method in accordance with an embodiment of the present invention.

FIG. 3 depicts example hardware components in device capable of implementing embodiments of the method and system disclosed herein.

FIG. 4 is a block diagram illustrating a first device in accordance with an embodiment of the present invention.

### DETAILED DESCRIPTION OF THE INVENTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

An embodiment of the present invention relies upon the concept of a “micro-app” (short for micro-application), which resides on one or more user devices. These micro-apps are designed to utilize context information in order to query one or more micro-app partners for result information. The context information can involve the media itself, the user, the device, the general environment, or social network. Once this result information is received from the micro-app partner(s), it can be presented on the user devices. In this manner, the micro-apps provide the ability to automatically retrieve results relevant to the currently-playing media and display them to viewers as the media is being played.

In an embodiment of the present invention, the context information is additionally utilized in order to dynamically alter a revenue sharing model. The micro-app framework creates “toll bridges” among the decoupled full-app partners, micro-app partners, and users, as well as among various micro-transactions. Each of these toll-bridges provides a potentially new revenue stream. Each of the revenue streams can then be dynamically modified at run-time based on various context information, allowing for a uniquely optimized revenue model.

The context information can be retrieved from a number of different sources. One source is the media being played itself. This type of context information may be called “media content context information” and may include any information about the media itself. One common source for such information can be metadata that accompanies the media. For television broadcasts, this information may be embedded in a digital broadcast stream. For over the top (OTT) video on demand (VOD) videos or photos, this information may be encoded in the downloaded media files, or may be transmitted separately. For DVD or Blu-Ray™ discs, this information may be encoded on the disk itself (such as in a dedicated metadata file), or may be available externally, such as using an external GD3 identification database. Normal video, photo, or music files stored on a hard disk drive can contain metadata information within the files themselves, such as the ID3 metadata in an mp3 file, or an xif file for a digital camera. Digital Living Network Alliance (DLNA) streams can include embedded metadata as well. Example of media content context information may include titles, genres, actors, directors, running times, scene information, music tracks, composers, authors, etc. Additional file streams, such as from social networking websites or from video streaming web sites can also be utilized with embodiments of the present invention. Additionally, files from non-media applications can also be utilized, such as news, maps, games, etc.

It should also be noted that the term “content provider” as used in this document shall be construed broadly to cover any entity that provides information or services that may be desired by the user. This may include textual information, graphical information, shopping capabilities, mapping tools, and so on. It may include more traditional content providers, such as movie studios, distributors, television stations, web sites, etc as well as service providers. While some in the art make a distinction between “service provider” and “content provider,” others in the art recognize that many providers blur the line between providing content and providing services and simply group all providers under the single title of “content provider.” It is this latter definition that is used throughout this document.

It should also be noted that the term “media” as used in this document shall be interpreted broadly to include more than just traditional video, photos, and text, but also other information for user viewing or listening that is transmitted to a device. Thus, “media” can include, for example, text in a newsreader application, maps in a mapping application, or graphics in a game application, and thus the “media content context information” can include context information regarding these items as well. In some places in this document, the term “full-app content” is used in the place of media content to make explicitly clear that even non-media related content can be used as the basis for context information and for retrieving results related to the full-app content. Furthermore, this “full-app content” can come from many sources, including live television, media players, micro-app results, DVDs, HDMI ports, etc.

It should also be noted that the term “micro-app” as used in this document shall be interpreted broadly to include ay application that can be installed on a device that queries a content provider. However, in some embodiments the micro-app is connected to another application or service and provides limited micro-functions within the full-application or service (called “full-app”). For example, an Amazon™ application might provide a full user interface to the Amazon.com™ marketplace, but an Amazon™ micro-app may provide only limited micro-functions (such as automatic search based on context, limited purchasing ability, etc.). A micro-function is a function that performs merely one action, such as “add-to-cart” or “add-to-favorites”.

It should also be noted that the concept of a “full-app” is evolving. While it used to mean a full fledged independently executable software application, many newer mobile apps are merely html pages running natively on a handheld device rather than being downloaded or stored on the device as a separate software application. The same is happening to television apps where rather than going to an app store and downloading or storing an app on the television, the app is just a blank pointer to a web resource that provides a customized TV-friendly experience. The notion of “full-apps” in this document shall be construed broadly to encompass all of these embodiments.

There are various other sources for context information than merely the media or full-app content itself. One such other source for context information is the user. Various information about the user can be retrieved either explicitly or implicitly. For example, a user profile may be stored that contains user information such as age, sex, interests, profession, etc. This type of context information may be useful in determining which information to retrieve from the content providers. For example, if a family is viewing a documentary program about Africa, it may be desirable to deliver to the children pictorial information about lions, giraffes, rhinoceroses, etc. (which can be delivered directly to the children's devices), while simultaneously delivering to the adults textual information about the history of the region being observed on adults' devices (or on a shared device). By including not only the media content context information but also the user context information, the system is able to deliver such personalization to individual devices.

The user profile is an example of explicitly-specified user context information, but this information may also be deduced from implicit sources. For example, the system may be able to deduce that a user is a child by examining the application usage history (or even just the applications loaded) on the user's device. If, for example, the device contains a lot of games typically played by young children, it can be deduced that the user of the device is a child.

Another source for context information is the device (for example, a television, mobile phone, computer, etc.). Various information about the device can be retrieved either explicitly or implicitly. For example, a device profile may be stored that contains device information such as manufacturer, memory, processor speed, display characteristics, input devices, etc. This type of context information may also be useful in determining which information to retrieve from the micro-app partners. For example, if a family is viewing a comedy program, the system may determine it would be beneficial to distribute relevant information about the lead actor to the various devices, including, for example, information about recent projects that the lead actor is appearing in. If one device has much greater processing speed, memory availability, and display characteristics than another, it may be desirable, for example, to provide a video movie trailer for a recent movie the actor has appeared in to the more powerful device, while the less powerful device receives only textual information about the actor's new movie.

A device profile is an example of explicitly-specified device context information, but this information may also be deduced from implicit sources. For example, the system may be able to deduce that the device has the capability to play high definition video if there are a number of high-definition video files stored in the memory of the device.

Another source for context information is the environment in which the device is operating. This may include a variety of different things, including external environmental information (time of day, temperature, location, etc.) and internal environmental information (operating system, other applications being run simultaneously, etc.). This type of context information may also be useful in determining which information to retrieve from the micro-app partners. For example, if the location of the device is “at home,” then the additional data downloaded from micro-app partners may be more recreational than if the device is “at work.”

External context information can be retrieved from a variety of external sensors or devices. For time of day, for example, a clock device located on a motherboard may be accessed. For location, a global positioning sensor (GPS) or similar tracking device may be utilized. For temperature, a temperature sensor may be utilized (alternatively, location information may be fed to an external database where current temperature can be retrieved for the location).

Another source for context information is social networking data. For example, user status information from social networking web sites or data streams can be examined to determine a current status for the user, which then may be used to aid in serving results. For example, if the user indicated a Facebook™ status as “on vacation,” a different set of results may be served than if the user had indicated that he was “at work.”

Another source for context information is the business partnership between the entities in the system. For example, a content provider may have a contract with an app store or with micro-app developers, and information from this contract may be relevant in helping design the revenue percentages.

In another embodiment, different weights can be assigned to different contexts according to other contexts. For example, a different weight may be assigned to a device of one user versus if that same device were operated by another user.

In another embodiment of the present invention, a “middleware” framework is provided that segregates micro-app partners from the micro-apps (and even from the micro-app companies, in some embodiments). The framework allows it to not be necessary for the micro-app partners to even be aware of the micro-app companies, and vice-versa. Both entities can simply program against the middleware framework APIs. In this manner, any application or source (e.g., Blu-Ray™, Netflix™, DLNA media, WiseLink, non-media widgets) can collaborate with any other services (micro-apps) without any knowledge of the service convergence or mash-up outcomes. Additionally, the framework can automatically provide other context and a unified user interface for multiple devices. Using various artificial intelligence engines, the framework can automatically improve the quality of micro-service search results. Algorithms can include dynamic lookup tables based on multi-context info.

Various mechanisms to monetize the above processes and systems are also anticipated. In one embodiment, micro-app partners compensate both the system operator or manufacturer (e.g., the operator of the micro-app store) and the media companies that encode their media data with the appropriate metadata (in the appropriate format). This compensation may be, for example, based on purchases made using the micro-apps, such that when a user makes a purchase at the micro-app partner (e.g., buys a related toy from Amazon™), the micro-app store and the media company are compensated out of the proceeds. In another embodiment, the compensation may be based on the number of page views (or “clicks”) received at the micro-app partner from micro-apps from the micro-app store and based on media produced by the media companies. Such “per click” compensation may be more beneficial for micro-app partners that do not sell products, but rather generate income based on advertising, such as a mapping micro-app partner. In another embodiment, lump sum payments are simply made periodically as part of a partnership agreement between micro-app partners and the operator of the micro-app store and media companies.

In another embodiment of the present invention, income generated by subscriptions to the media companies (e.g., Netflix™ subscriptions) can be shared with the micro-app store operator, to the extent that the micro-app store creates new subscription opportunities for the media companies.

In another embodiment of the present invention, an affiliate and referral system is designed to include other entities other than the media companies, micro-app store operator, and micro-app partners. This may include, for example, compensating owners of additional web sites (affiliates) that drive traffic to the micro-app store and from which money is generated for either the media companies or the micro-app partners. The system may be designed to track an affiliate ID as part of this process to ensure proper credit is given. This affiliate ID may be tracked, for example, as part of a cookie stored during a network session.

In another embodiment of the present invention, certain micro-apps may be considered “premium” micro-apps, requiring the user to subscribe or purchase the micro-app from the micro-app store operator. Portions of this income generated may be shared with the media companies and/or micro-app partners.

In another embodiment of the present invention, income generated from the rental or purchase of digital information (e.g., media) from either the media companies or micro-app partners can be shared among the media companies, micro-app store operator, and/or micro-app partners.

As described briefly above, the revenue sharing may be performed dynamically, relying on context information to dynamically alter the percentage of revenues given to any entity. The revenue splits can vary depending upon implementation, but generally any entity participating in the chain of recommending or purchasing an item or service can receive a percentage of the revenues. For example, rather than simply split revenue between app store partners and app store developers, micro app partners can also receive a share of revenues. For example, an Amazon™ micro-app may act to retrieve context information from a Netflix™ streaming video full-app about a movie currently being viewed. The Amazon™ micro-app may then cause related products from an Amazon™ database to be displayed to the viewer. If the viewer purchases one of the items, revenue may be shared among Netflix™ (the full-app partner), Amazon™ (the micro-app partner), and the App store owner. Furthermore, if the viewer, rather than directly purchase the item, actually recommends the item to a friend and the friend winds up purchasing the item, the viewer may participate in the revenue sharing as well.

Revenue may be shared based on more than merely product purchases as well. For example, the micro-app partner may decide to pay participants merely for the chance to sell the product, based on, for example, the number of views of the products. As such, the micro-app partner may decide to pay the App store owner and/or the full-app partner each time one of the products is displayed to the viewer.

Furthermore, in an embodiment of the present invention, the context itself alters the parameters of the revenue sharing. In this manner, unlike traditional advertising, different revenue sharing parameters can exist for displaying items to different viewers under exactly the same circumstances. For example, the revenue sharing parameters can be different for viewer A than for viewer B, even though both are watching the same movie at the same time with the same type of equipment. The context information that these revenue sharing parameters is based on can of course vary greatly from implementation to implementation. Information from a user's profile, such as age, sex, and interests, for example, could be utilized to have different revenue sharing parameters for products shown to different users. In this way, for example, the micro-app partner could pay a higher percentage of revenue for highly desirable customers, such as those in key demographics, who are likelier to turn into repeat customers.

Basing the revenue sharing parameters on context information also allows the revenue sharing parameters to vary based upon more than just user information. For example, the micro-app partner could decide to pay a higher percentage of revenue in the middle of the night than during the day, as viewers in the middle of the night may have a higher propensity to purchase viewed items. Alternatively, the micro-app partner could decide to pay a higher percentage of revenue when the weather is bad (snow, rain, etc.) than when the weather is good, for the same reason.

The revenue sharing parameters can be altered dynamically in real time based upon whatever context information is selected. The parameters can be manually specified, or derived/determined using an algorithm. This allows for a completely fluid system that can be easily optimized to provide the best results of all parties involved.

It should also be noted that an embodiment is possible where more entities share in the revenue stream than those mentioned earlier. For example, a “middle partner” having an associated micro-app or micro-apps may intercept content being played or displayed by a full-app or micro-app and augment the context of the content with additional context. This middle partner may then share in the revenue by being dynamically assigned a revenue percentage as well.

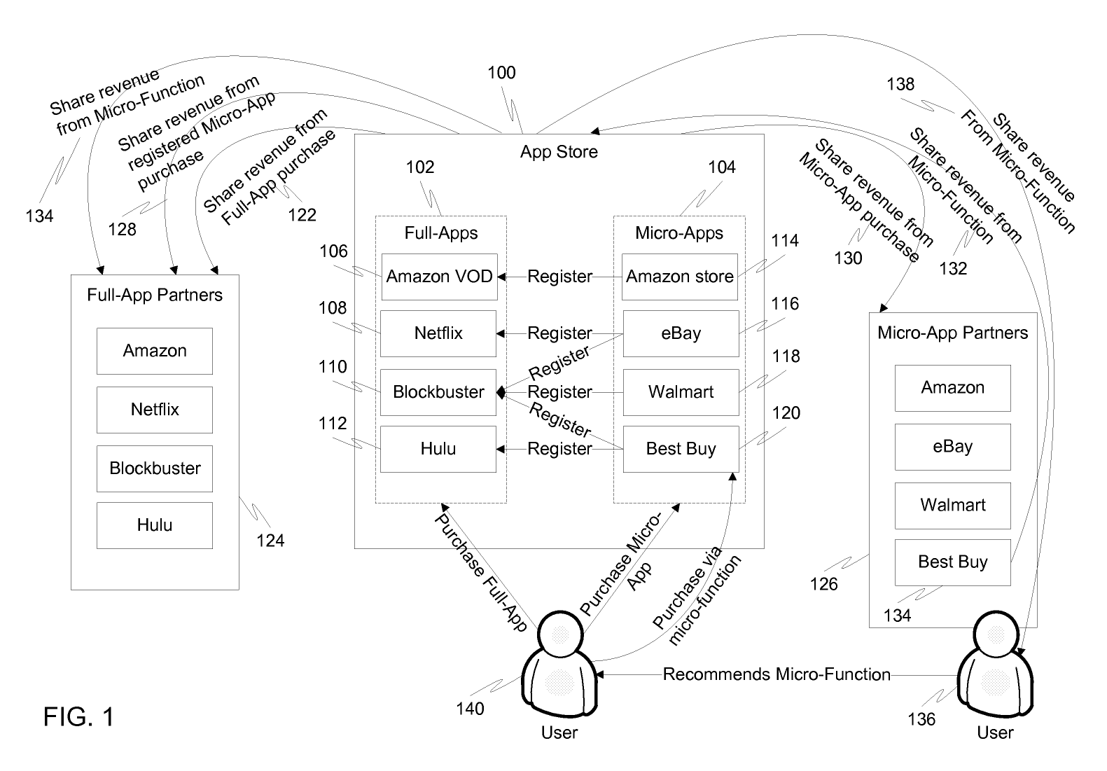

FIG. 1 is a diagram illustrating a micro-app system in accordance with an embodiment of the present invention. As can be seen, an App Store 100 may offer full-apps 102 as well as micro-apps 104 for download (either free or by purchase). In this example, an Amazon™ video on demand full-app 106, a Netflix™ streaming video full-app 108, a Blockbuster™ streaming view full-app 110, and a Hulu™ streaming video full-app 112 are provided.

Additionally, an Amazon™ store micro-app 114, an eBay™ micro-app 116, a Wal-Mart™ micro-app 118, and a Best Buy™ micro-app 120 are provided. Each of these micro-apps 104 may register with one or more full-apps 102. In this example, there are various potential revenue streams. First, when the user purchases and downloads a full-app, the app store may share revenue with the full-app partner. This is depicted as 122 in the figure. As can be seen, it may be based per user, per device, or per transaction. This percentage can vary in real time based on context information.

The full-app will also have access to available and downloaded micro-apps that have registered with it. While registration is not strictly required in order to interface a micro-app with a full-app, it does allow the micro-app to announce itself as part of the revenue chain. The full-app can decide which micro-apps to present, which order, which presentation style and preview, for example, in which to present the micro-apps. The purchase of a micro-app can generate revenue to be shared from the App Store 100 with the full-app partner 124, as well as with the micro-app partner 126. Of course, the revenue sharing parameters can also vary based upon the order in which the micro-apps are presented, or their presentation style and preview. For example, micro-apps that are displayed more prominently (such as higher up in a list or with a special font or formatting) can provide a higher percentage of revenue to the full-app partner than those displayed less prominently. 128 depicts the sharing of revenue from a registered micro-app purchase with a full-app partner. 130 depicts the sharing of revenue from the same micro-app purchase with the micro-app partner. Additionally, the device parameters themselves can alter the revenue percentages. For example, advertisements shown on a 65″ television may be priced or calculated differently than advertisements shown on a 32″ television and differently than on a 3″ mobile phone display.

Another revenue stream comes from actions taken within a micro-function of a micro-app. This could include a purchase made using the micro-function, but can also include non-purchase related activities. For example, the micro-app partner may wish to reward the full-app partner for every search conducted via the micro-function. As such, 132 depicts a percentage of revenue being passed from a micro-app partner (here, Best Buy™ 134), which had received a purchase request via micro-app 120. Revenue may then be sent from Best Buy™ 132 to the App Store 100, which may then distribute some or all of that revenue to an appropriate full-app partner (this revenue sharing is depicted at 134). Furthermore, a user 136 himself can also receive revenue shared from a micro-function purchase (depicted at 138), due to the fact that user shared the item that was eventually purchased by user 140.

It should be noted that not just the percentage of revenue shared can be altered dynamically based upon the factors described above. Additional “compensation”-related aspects can be adjusted based on these factors. For example, an app store may deice to reward a service provider by featuring its app more often or more prominently. As such, not just the percentage of compensation can be adjusted dynamically but also the type of compensation can be adjusted dynamically.

Tracking of the various revenue aspects can be performed in a variety of ways. In one embodiment, any entity that wishes to participate in the revenue stream can register with the App Store (this could include full-app partners, micro-app partners, and users), and the App Store manages the payments based on a matrix maintained by the App Store. In other embodiments, a third party payment management service may be used.

In another embodiment of the present invention, it is not merely the context information itself that is used to alter the revenue sharing percentages, but the quantity of context information. Devices, for example, that share more context information may receive higher percentage shares for its users than those that share less. Likewise, partners of micro-apps that provide more context information back to the full-app may receive higher percentage shares than partners of micro-apps that provide less context information back to the full-app. A similar concept can be applied for “quality”. For example, a micro-app that returns results faster or returns more relevant results based on a certain metric could also be rewarded more than one that does not.

In another embodiment of the present invention, user feedback can be taken into account when determining revenue sharing percentages. For example, if users interact longer with a search result, or purchase it rather than merely view it, share it with friends, bookmark it, or in any other way interact with the results more, the result provider could be more richly rewarded in a higher revenue sharing percentage.

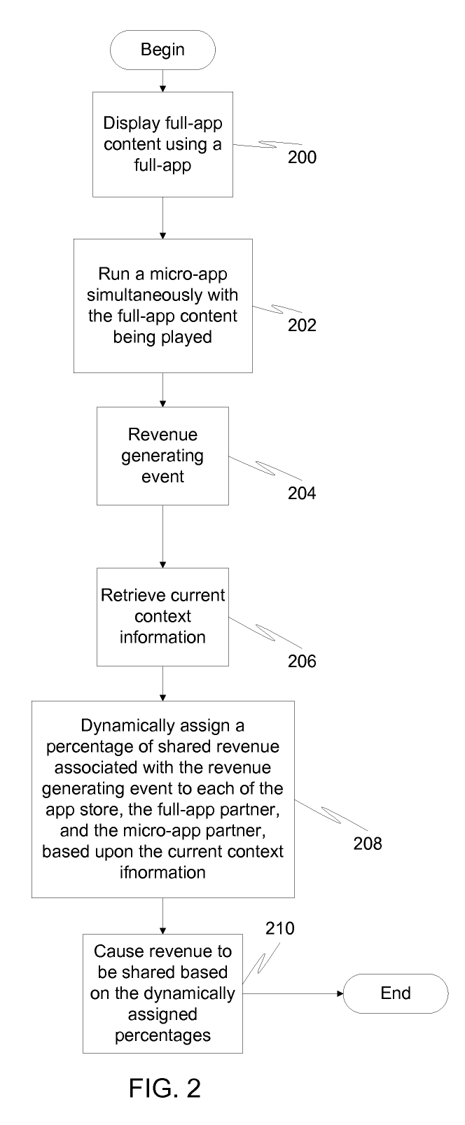

FIG. 2 is a flow diagram illustrating a method in accordance with an embodiment of the present invention. At 200, full-app content is displayed using a full-app on a first device, wherein the full-app is associated with a full-app partner and was downloaded from an app store. At 202, a micro-app is run simultaneously with the full-app content playing on the first device, wherein the micro-app is associated with a micro-app partner. At 204, a revenue generating event on the first device. The revenue generating event can be anything that, directly or indirectly, generates revenue for some party. The most common example may be the purchase by a user of the first device of a product, service, micro-app, or full-app by using the interface of the micro-app. Other examples include purchases made by other users as well as non-purchase events such as the displaying of links within the micro-app that the micro-app partner wishes to provide compensation for.

At 206, current context information is retrieved. This context information may be retrieved in a number of different ways. In one embodiment, the full-app content context information is embedded as metadata in the media file or media stream, and the micro-app can intercept and decipher this embedded context information. In another embodiment, the fill-app content context information is deduced, either by the micro-app alone or in conjunction with other applications, some of which can be run on separate devices (such as a server that can be queried by the micro-app via the Internet).

At 208, a percentage of shared revenue associated with the revenue generating event is dynamically assigned to each of the app store, the full-app partner, and the micro-app partner, based upon the current context information. It should be noted that in some embodiments one or more users may also be assigned a percentage. A user may be assigned a percentage, for example, if he or she made a recommendation to another user that eventually resulted in a revenue generating event (such as the other user making a purchase based on the recommendation). At 210, revenue associated with the revenue generating event is caused to be shared among the app store, the full-app partner, and the micro-app partner, based on the dynamically assigned percentages. In embodiments where one or more users are also dynamically assigned percentages, they can also receive revenue at this step as well, in accordance with their assigned percentages.

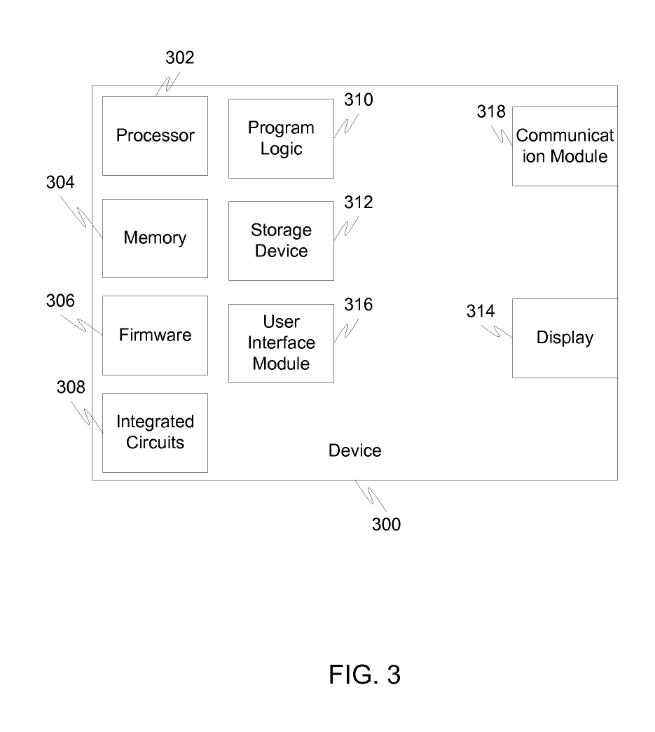

FIG. 3 depicts example hardware components in device capable of implementing embodiments of the method and system disclosed herein. In one embodiment, the device 300 comprises a television having a processor 302, memory 304, firmware 306, integrated circuits 308, program logic 310, a storage device 312, a display screen 314, a user interface module 316, and a communication module 318. The communication module 318 may be, for example, a network interface device or a wireless radio transmitter/receiver.

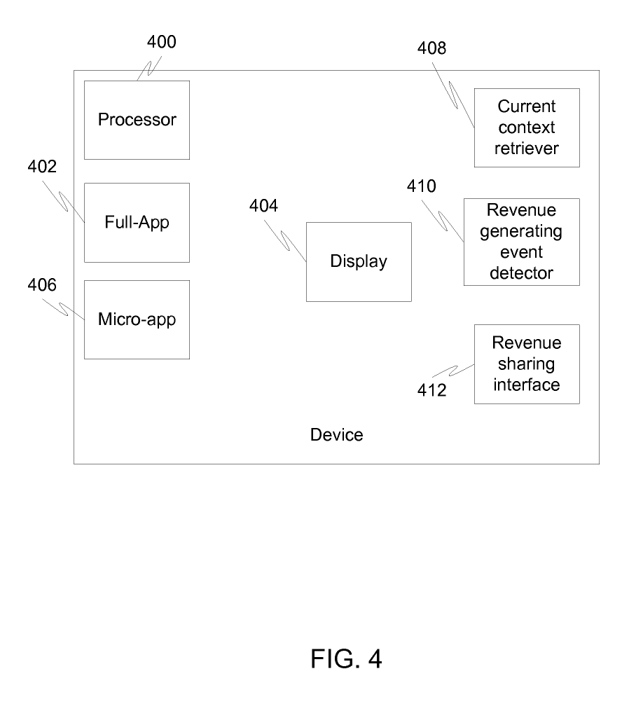

FIG. 4 is a block diagram illustrating a first device in accordance with an embodiment of the present invention. A processor 400 may act to execute many, if not all, the functions of the present invention. A full-app 402 may be configured to display full-app content on a display 404. A micro-app 406 may be configured to run simultaneously with the full-app content being displayed on the display 404. A current context retriever 408 may be configured to retrieve current context information. The current context retriever 408 could also include one or more hardware sensors, such as clocks, temperature gauges, GPS devices, etc. that can gather context information.

A revenue generating event detector 410 may then be configured to detect a revenue generating event by the micro-app 406. A revenue sharing interface 412 may be designed to send the current context information to a revenue distributing entity upon the revenue generating event detector 410 detecting a revenue generating event by the micro-app, so that the revenue distributing entity can dynamically assign a percentage of shared revenue to each of the app store, a full-app partner associated with the full-app, and a micro-app partner associated with the micro-app, based on the current context information, and cause revenue associated with the revenue generating event to be shared based on the dynamically assigned percentages.

In one embodiment of the present invention, the system is extended to a cloud. In this manner, for example, the raw context can be retrieved from any number of different devices in different locations. Consumers have been accumulating volumes of digital assets and using more and more Internet services. Consumers typically access these assets and services using more than one device. A typical consumer may have a desktop computer, a laptop computer, and a cell phone (and possibly other devices as well) that can all be used to access and gather information and media. The trend will continue while huge amounts of services and contents are made available on the Web daily. These assets and services are typically scattered around in personal devices as well as in various informal groupings of information known as clouds. A cloud is a formal or informal grouping of information based on control. The present invention anticipates extending the augmented context systems in a similar manner. Additionally, the logic for detecting or generating revenue share events can also be placed in the cloud as opposed to on one of the other devices, such as a television or mobile device.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method comprising:
displaying full-app content using a full-app on a first device, wherein the full-app is associated with a full-app partner and was downloaded from an app store;
running a micro-app simultaneously with the full-app content playing on the first device, wherein the micro-app is associated with a micro-app partner;
performing a revenue generating event on the first device;
retrieving current context information;
dynamically assigning a percentage of shared revenue associated with the revenue generating event to each of the app store, the full-app partner, and the micro-app partner, based upon the current context information; and
causing revenue associated with the revenue generating event to be shared among the app store, the full-app partner, and the micro-app partner based on the dynamically assigned percentages.

2. The method of claim 1, wherein the current context information includes full-app content context information associated with the full-app content playing on the first device.

3. The method of claim 2, wherein the full-app content context information is determined by examining metadata of the full-app content.

4. The method of claim 1, wherein the current context information includes user context information associated with a user of the first device.

5. The method of claim 1, wherein the current context information includes device context information associated with the first device.

6. The method of claim 1, wherein the current context information includes environmental context information associated with the first device.

7. The method of claim 1, further comprising dynamically assigning a percentage of the shared revenue associated with the revenue generating event to a first user, the first user operating the first device, and wherein the causing further includes causing revenue associated with the revenue generating event also to be shared with the first user based on the dynamically assigned percentage to the first user.

8. The method of claim 1, wherein a first user operates the first device, and wherein the method further comprises dynamically assigning a percentage of the shared revenue associated with the revenue generating event to a second user, the second user operating a device other than the first device, and wherein the causing further includes causing revenue associated with the revenue generating event also to be shared with the second user based on the dynamically assigned percentage to the second user.

9. The method of claim 1, wherein the revenue generating event is a purchase made by a first user of the first device through the micro-app.

10. The method of claim 1, wherein the revenue generating event is the display of information to a first user of the first device through the micro-app.

11. A first device comprising:
a processor;
a display;
a full-app downloaded from an app store, wherein the full-app is configured to display full-app content on the display;
a micro-app downloaded from the app store, wherein the micro-app is configured to run simultaneously with the full-app content being displayed on the display;
a current context retriever configured to retrieve current context information;
a revenue generating event detector configured to detect a revenue generating event by the micro-app; and
a revenue sharing interface designed to send the current context information to a revenue distributing entity upon the revenue generating event detector detecting a revenue generating event by the micro-app so that the revenue distributing entity can dynamically assign a percentage of shared revenue to each of the app store, a full-app partner associated with the full-app, and a micro-app partner associated with the micro-app, based on the current context information, and cause revenue associated with the revenue generating event to be shared based on the dynamically assigned percentages.

12. The first device of claim 11, wherein the revenue distributing entity is the app store.

13. The first device of claim 11, wherein the revenue distributing entity is an entity other than the app store, the full-app partner, or the micro-app partner.

14. An apparatus comprising:
means for displaying full-app content using a full-app on a first device, wherein the full-app is associated with a full-app partner and was downloaded from an app store;
means for running a micro-app simultaneously with the full-app content playing on the first device, wherein the micro-app is associated with a micro-app partner;
means for performing a revenue generating event on the first device;
means for retrieving current context information;
means for dynamically assigning a percentage of shared revenue associated with the revenue generating event to each of the app store, the full-app partner, and the micro-app partner, based upon the current context information; and
means for causing revenue associated with the revenue generating event to be shared among the app store, the full-app partner, and the micro-app partner based on the dynamically assigned percentages.

15. A non-transitory program storage device readable by a machine tangibly embodying a program of instructions executable by the machine to perform a method comprising:
displaying full-app content using a full-app on a first device, wherein the full-app is associated with a full-app partner and was downloaded from an app store;
running a micro-app simultaneously with the full-app content playing on the first device, wherein the micro-app is associated with a micro-app partner;
performing a revenue generating event on the first device;
retrieving current context information;
dynamically assigning a percentage of shared revenue associated with the revenue generating event to each of the app store, the full-app partner, and the micro-app partner, based upon the current context information; and
causing revenue associated with the revenue generating event to be shared among the app store, the full-app partner, and the micro-app partner based on the dynamically assigned percentages.
